(19) United States
(12) Patent Application Publication
(10) Pub. No.: US 2016/0020553 A1
(43) Pub. Date: Jan. 21, 2016

(54) ASSEMBLY WITH LGA CONTACTS FOR INTERCONNECTION

(71) Applicant: FOXCONN INTERCONNECT TECHNOLOGY LIMITED, Grand Cayman (KY)

(72) Inventor: TERRANCE F. LITTLE, Fullerton, CA (US)

(21) Appl. No.: 14/804,256

(22) Filed: Jul. 20, 2015

Related U.S. Application Data
(60) Provisional application No. 62/026,046, filed on Jul. 18, 2014.

(51) Int. Cl. H01R 13/62; H01R 13/629

(52) U.S. Cl. CPC H01R 13/6205; H01R 13/62905

(57) ABSTRACT

An assembly includes a first device defining a first mating area and a second device defining a second mating area for mating with the first mating area. The first mating area includes magnets and conductive pads, the second mating area includes corresponding magnetic elements and LGA contacts. Said LGA contacts extend beyond a mating face of the second mating area when said first mating area and said second mating area are mated with each other by attractive combination of the magnetic element and the corresponding magnet while are retracted behind a mating face of the second mating area when the first mating area and the second mating area are separated from each other.

This application claims the benefit of, and priority to U.S. Provisional Patent Application No. 62/026,046, filed Jul. 18, 2014, the contents of which are incorporated entirely herein by reference.

### BACKGROUND OF THE INVENTION

1. Field of the Invention

The present invention relates to an assembly of two devices for interconnection, and more particularly to a LGA contact interconnection applied to the two devices.

2. Description of Related Art

The interfaces for interconnection of electrical devices has been designed as many types of connectors such as USB, HDMI, DisplayPort etc. However, these I/O connectors have their defects at the development tendency of miniaturization, high density and reliablility. The LGA (stands for Land Grid Array) connector is one of the most favorable and user-friendly products for electrical connection of a chip package and a printed circuit board, the LGA connector could keep up with the trends by means of providing contacts in a high-density manner and pressure interconnection which differs from the traditional I/O connectors with insertable interconnection.

Hence, a new interface for interconnection of electrical devices are desired to improve those disclosed in the aforementioned proposal.

### SUMMARY OF THE INVENTION

According to one aspect of the present invention, an assembly comprises a first device defining a first mating area and a second device defining a second mating area for mating with the first mating area. The first mating area includes magnets and conductive pads, the second mating area includes corresponding magnetic elements and LGA contacts. Said LGA contacts extend beyond a mating face of the second mating area when said first mating area and said second mating area are mated with each other by attractive combination of the magnetic element and the corresponding magnet while are retracted behind a mating face of the second mating area when the first mating area and the second mating area are separated from each other.

According to another aspect of the present invention, a device comprises a case including a mating face and a space behind the mating face; a connector wafer assembly retractably received in said space and including a plurality of LGA contacts; a first actuating device actuating the connector wafer assembly to move toward said mating face and drive the LGA contacts exposed upon the mating face when said device is being used; and a second actuating device actuating the connector wafer assembly to move away from said mating face and drive the LGA contacts hide behind said mating face when said device is out of use.

Other objects, advantages and novel features of the invention will become more apparent from the following detailed description when taken in conjunction with the accompanying drawings.

### BRIEF DESCRIPTION OF THE DRAWINGS

FIG. 1(A) is a front perspective view of an assembly of the display panel and the pocket PC

FIG. 1(B) is a rear perspective view of the assembly of FIG. 1(A).

FIG. 2(A) is an elevational view to show the mating area of the display panel of FIG. 1(B).

FIG. 2(B) is an elevational view to show the mating area of the pocket PC of FIG. 1(A).

FIG. 3 is a perspective view to show the pocket PC of FIG. 1(A).

FIG. 4(A) is an enlarged perspective view to show the main portion of the mating area of the display panel of FIG. 2(A).

FIG. 4(B) is an enlarged perspective view to show the main portion of the mating area of the pocket PC of FIG. 3.

FIG. 5 is a perspective view of the connector wafer assembly of the pocket PC of FIG. 3.

FIG. 6 is a cross-sectional view of the assembly of FIG. 1(A) wherein the display panel and the pocket PC are mated with each other.

FIG. 6(A) is an enlarged cross-sectional view of a portion of the assembly of FIG. 6.

FIG. 7 is a perspective view of the assembly of FIG. 1(A) wherein the display panel and the pocket PC are separated from each other.

FIG. 7(A) is an enlarged cross-sectional view of a portion of the assembly of FIG. 34.

FIG. 8 shows a perspective view to illustrate how the two mating areas are interacted with each other.

FIG. 9 shows an alternate embodiment to use the cam structure in place of the secondary magnetic elements.

### DETAILED DESCRIPTION OF THE PREFERRED EMBODIMENT

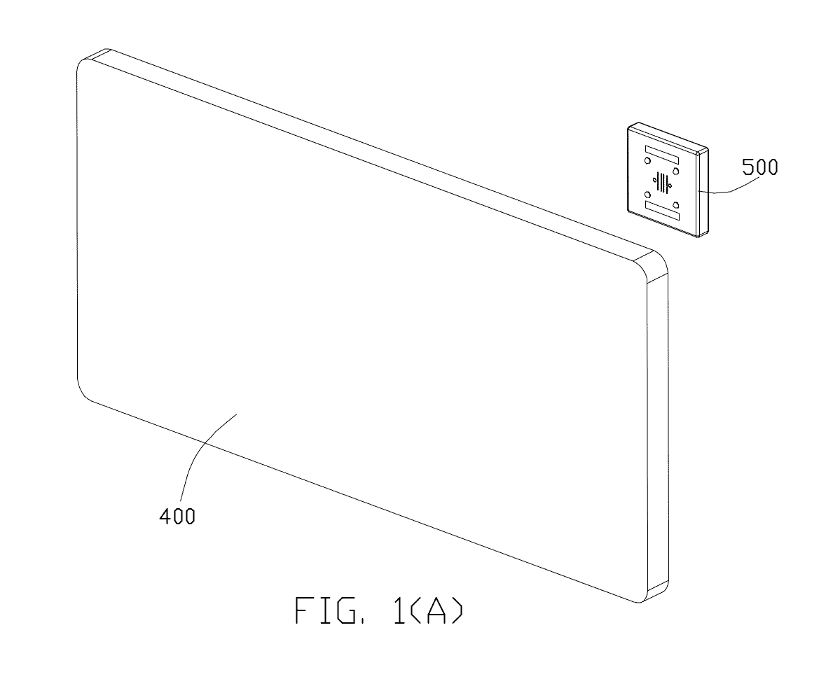

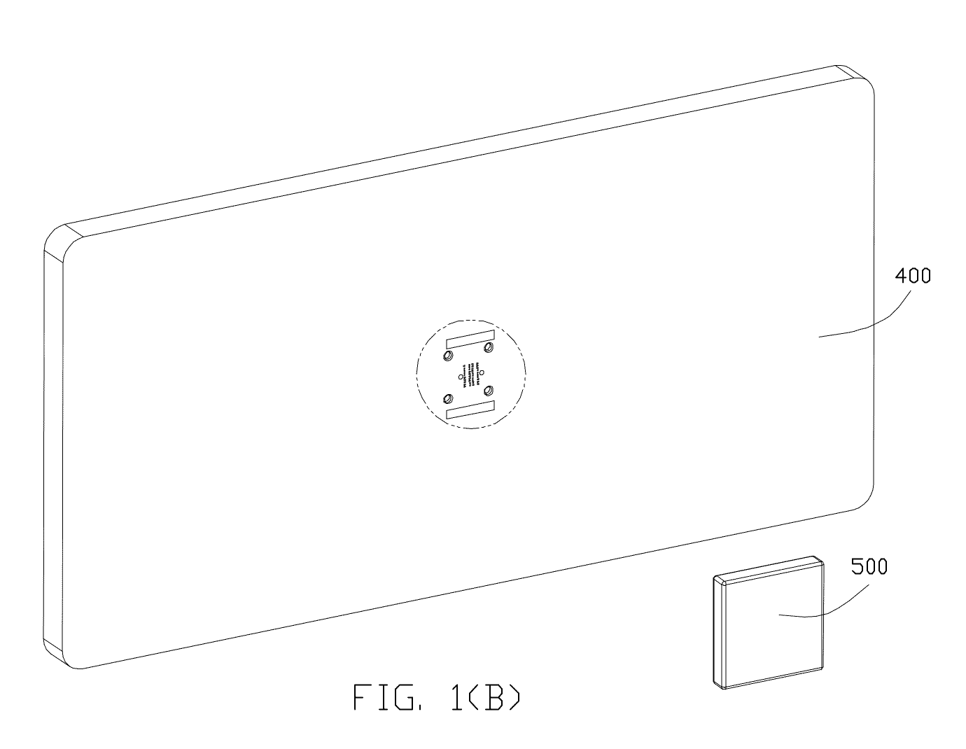

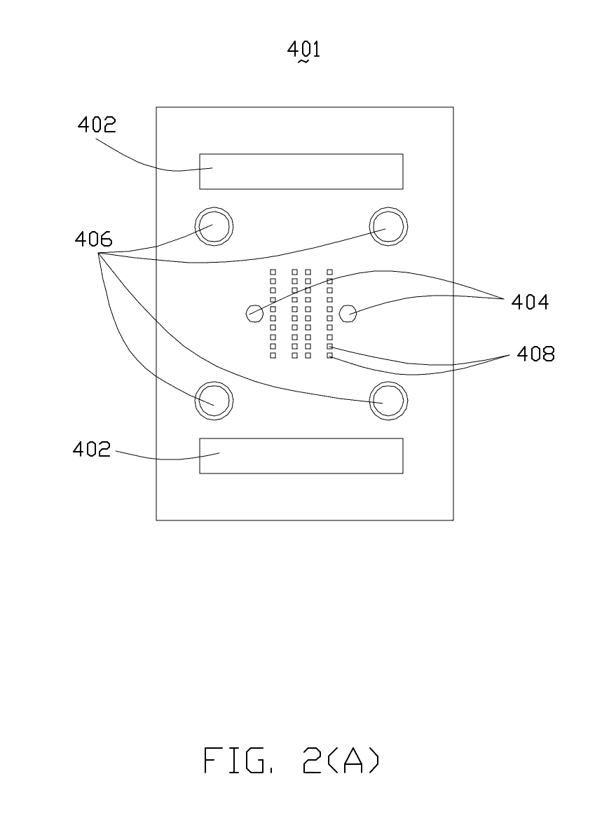

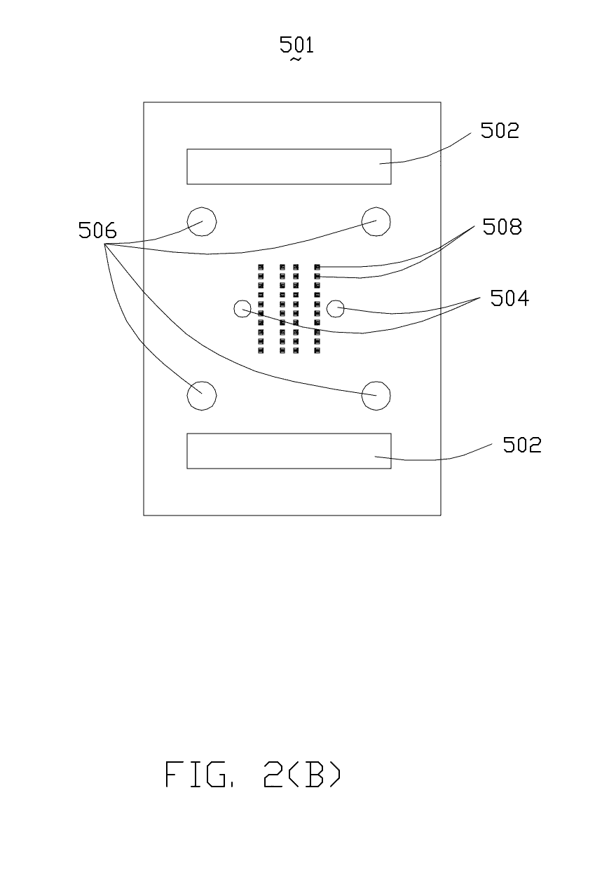

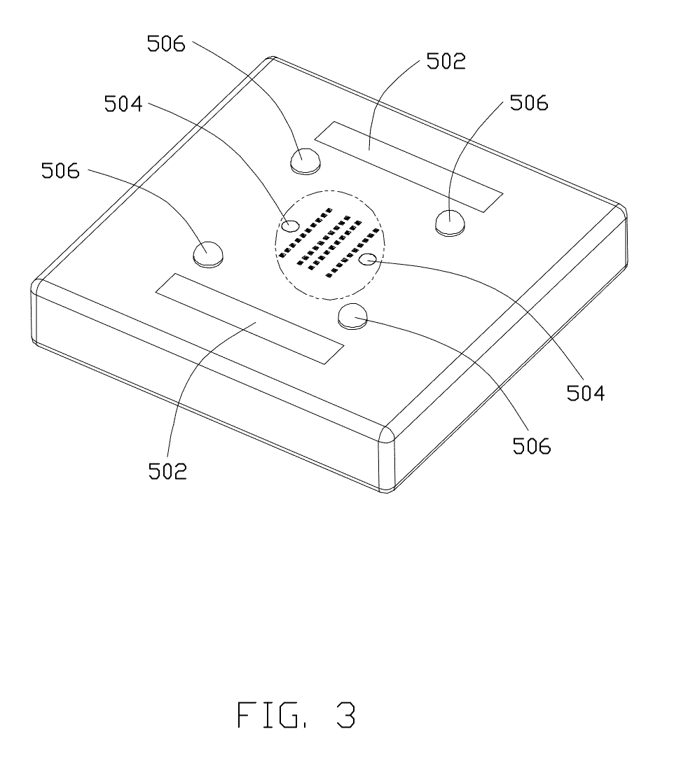

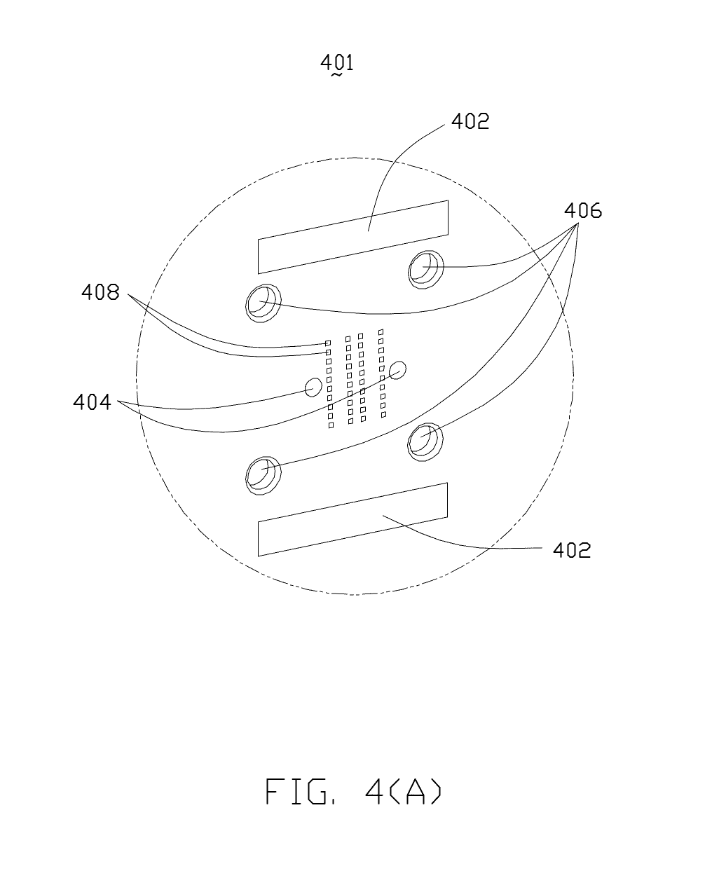

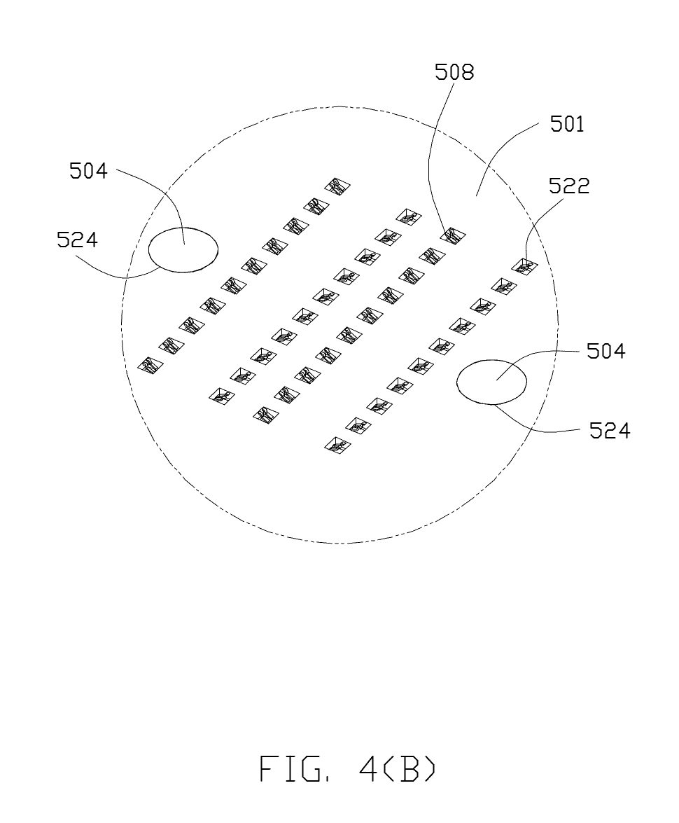

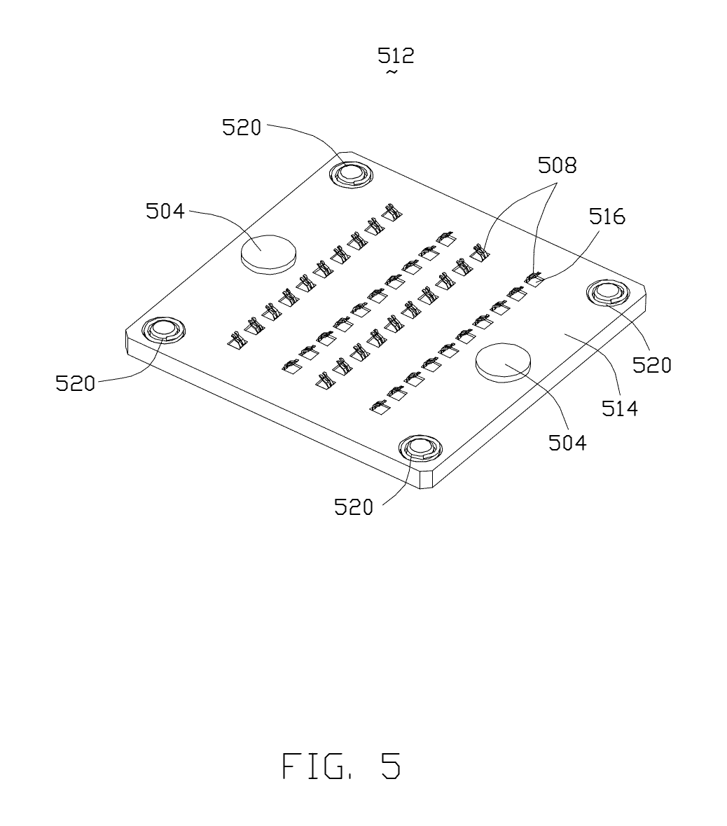

Referring to FIGS. 1(A)-9, a combination includes a display panel 400 and a pocket PC 500 mateable with the display panel 400. The mating area 401 of the display panel 400 includes a pair of primary magnets 402, a pair of secondary magnets 404 located at middle of the primary magnets 402, four alignment holes 406 and a plurality of LGA (Land Grid Array) pads 408. The mating area 501 of the pocket PC 500 includes a pair of primary magnetic elements 502, a pair of secondary magnetic elements 504, four alignment posts 506 and a plurality of LGA contacts 508.

The pocket PC 500 includes a case 510 forming a space receiving a connector wafer assembly 512 in a floating manner between upper and lower positions along vertical direction. The connector wafer assembly 512 includes an insulative housing 514 with a plurality of passageways 516 retaining corresponding contacts 508 therein wherein the contacting section of the contacts 508 upwardly extends above the upper surface of the housing 514. Four springs 520 are located at the four corners of the housing 514 to constantly urge the connector wafer assembly 512 to the lower position. The secondary magnetic elements 504 are formed upon the housing 514. Correspondingly, the case 510 forms a plurality of through holes 522 in alignment with the corresponding passageways 516, respectively, to allow the contacting sections of the contacts 508 to extend therethrough, and further forms a pair of openings 524 to receive the corresponding secondary magnetic elements 504 when the connector wafer assembly 512 is located at the upper position with regard to the case 510.

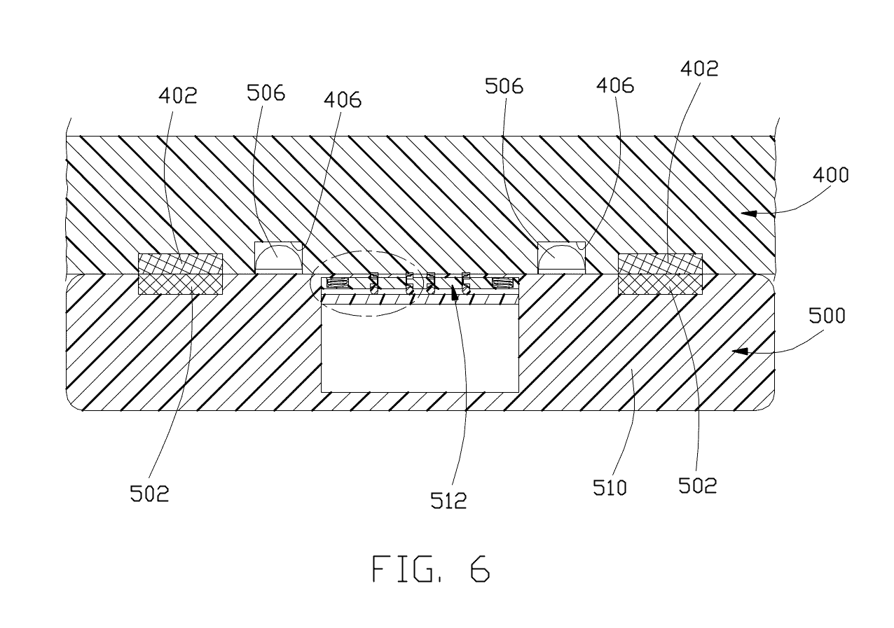

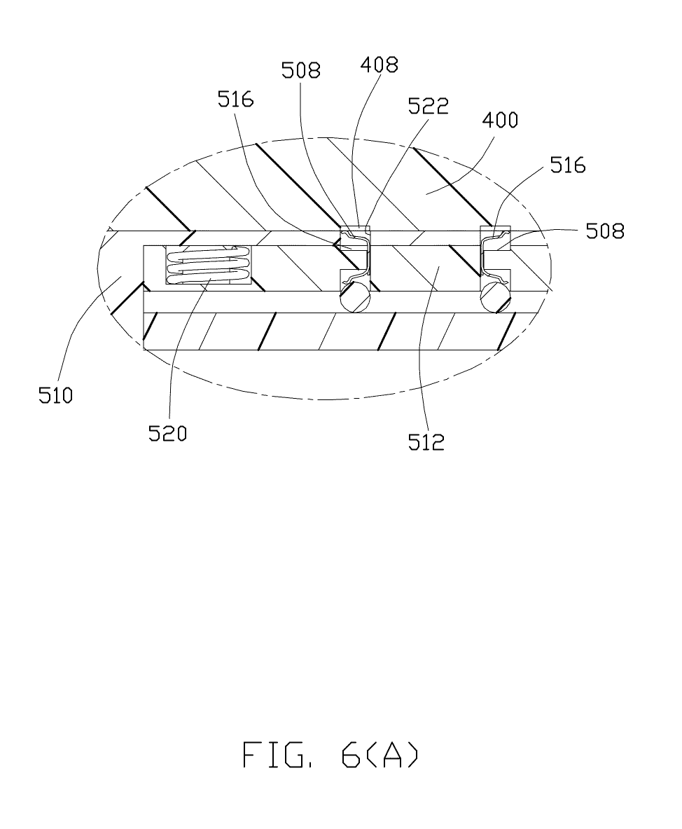

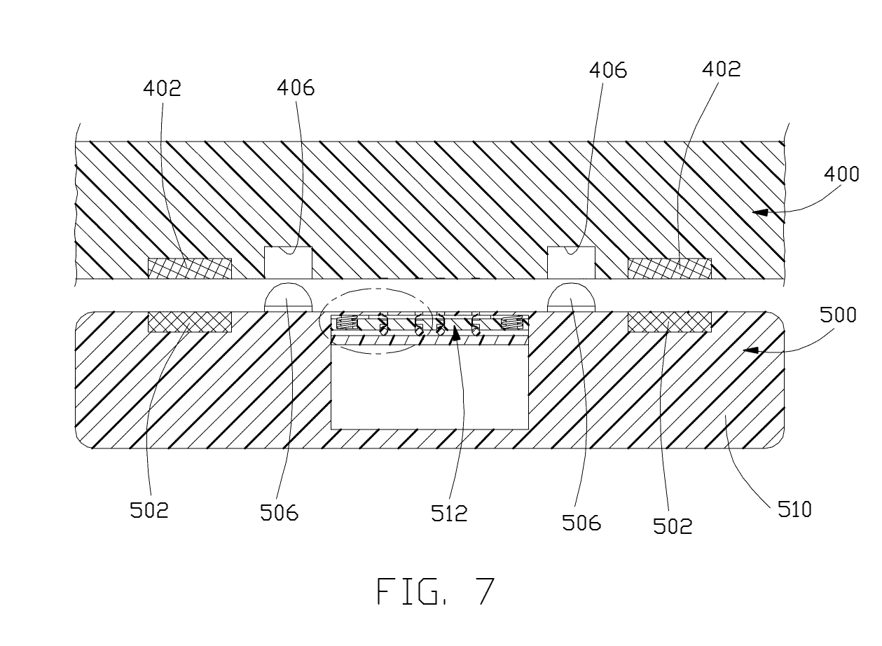

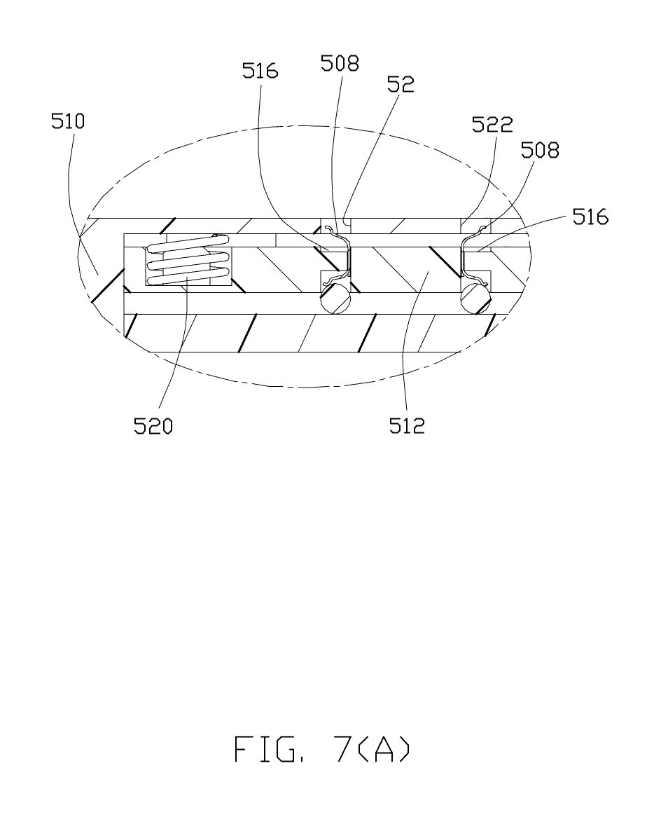

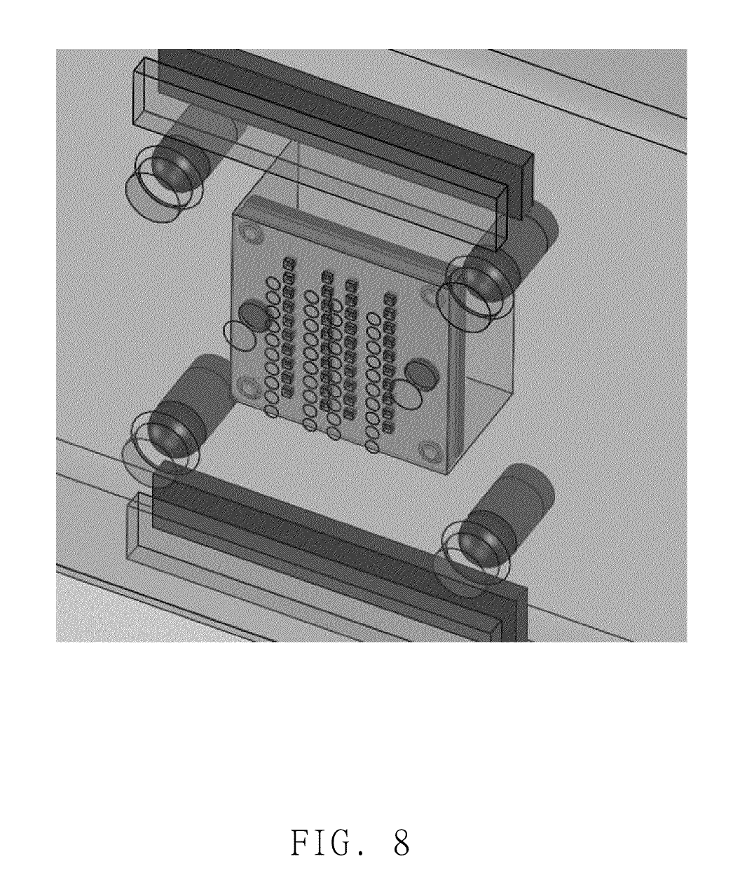

Referring to FIGS. 6, 6(A), 7 and 7(A), when the pocket PC 500 is mated with the display panel 400, the primary magnetic elements 502 of the pocket PC 500 and the primary magnets 402 of the display panel 400 are attracted and contacted with each other, the alignment posts 506 of the pocket PC 500 are received within the corresponding alignment holes 406 of the display panel 400. At the same time, the secondary magnetic elements 504 of the pocket PC 500 and the second magnets 404 of the display panel 400 are attracted with each other so as to compress the springs 520 to urge the connector wafer assembly 512 to upwardly move to have the contacting sections of the contacts 508 extend through the corresponding through holes 522 to contact the corresponding pads 408 wherein the connector wafer assembly 512 is located at the upper position relative to the case 510, and the secondary magnetic elements 504 are received in the corresponding openings 524 to upwardly intimately contact the second magnets 404, respectively. In opposite, detaching the pocket PC 500 from the display panel 400 by separating the primary magnetic elements 502 from the primary magnets 402 and the secondary magnet element 504 from the secondary magnets 404, the alignment posts 506 leave the corresponding alignment holes 406. At the same time, the connector wafer assembly 512 is moved to the lower position relative to the case 510 due to the resilient force of the spring 520 so as to assure the contacting section of the contacts 508 will not be damaged due to improper exposure. FIG. 8 illustrates interactive relation between the pocket PC 500 and the display panel 400 during mating.

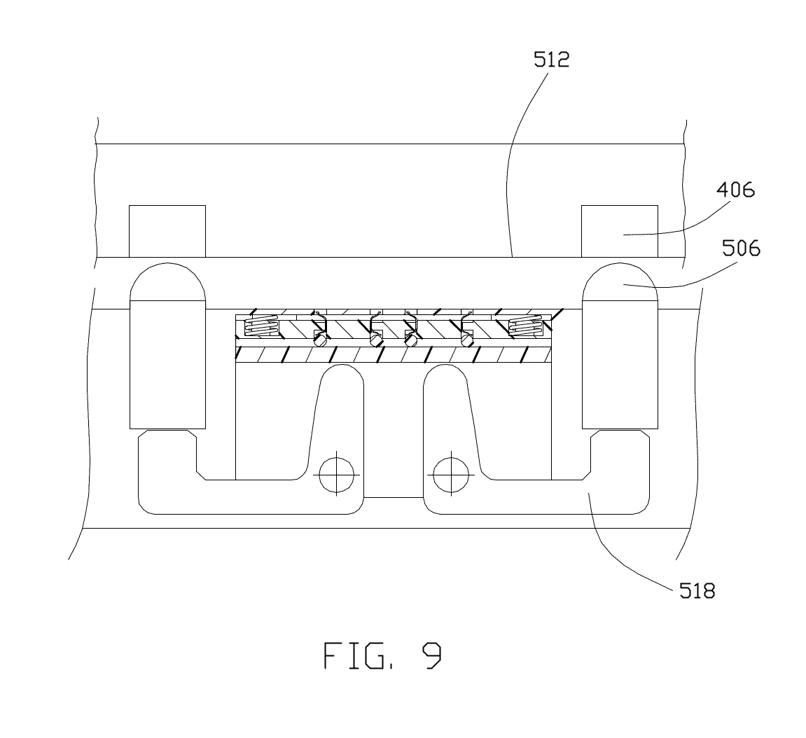

FIG. 9 shows another embodiment wherein a pivotal cam structure 518 is provided to lift the connector wafer assembly 512 upward when the alignment post 506 is received in the corresponding alignment hole 406 and downwardly pressed. In this embodiment, the secondary magnetic element of the pocket PC and the secondary magnet of the display panel may not be required any more.

What is claimed is:

1. An assembly comprising:
a first device defining a first mating area, the first mating area including magnets and conductive pads;
a second device defining a second mating area for mating with the first mating area, the second mating area including corresponding magnetic elements and LGA contacts; wherein
said LGA contacts extend beyond a mating face of the second mating area when said first mating area and said second mating area are mated with each other by attractive combination of the magnetic element and the corresponding magnet while are retracted behind a mating face of the second mating area when the first mating area and the second mating area are separated from each other.

2. The assembly as claimed in claim 1, wherein the contacts are mounted upon a connector wafer assembly which is floatable relative to a case of the second device.

3. The assembly as claimed in claim 2, wherein the magnets include a pair of primary magnets, the magnetic elements include a pair of immovable primary magnetic elements at outsides of the connector wafer assembly to attract with the primary magnets.

4. The assembly as claimed in claim 2, wherein the magnets include a pair of secondary magnets, the magnetic elements include a pair of secondary magnetic elements formed upon and movable with the connector wafer assembly, said secondary magnetic elements attract with said secondary magnets and actuate the connector wafer assembly to move toward said mating face with contacting sections of said contacts extending beyond said mating face and contacting said conductive pads of the first device.

5. The assembly as claimed in claim 4, wherein the second mating area has a pair of openings passing through the mating face to receive the corresponding secondary magnetic elements when the connector wafer assembly moves toward said mating face.

6. The assembly as claimed in claim 4, wherein the connector wafer assembly includes a housing defines a plurality of passageways with said contacts retained therein, the mating area has a plurality of through holes passing through the mating face and in alignment with the corresponding passageways to allow said contacting sections of said contacts to extend therethrough.

7. The assembly as claimed in claim 2, wherein the second device includes a plurality of springs sandwiched between said mating face and said connector wafer assembly and constantly urging said connector wafer assembly to move away from said mating face.

8. The assembly as claimed in claim 7, wherein the connector wafer assembly has four grooves formed on corners thereof to receive the corresponding springs and four pillars locating in the corresponding grooves to retain the corresponding springs.

9. The assembly as claimed in claim 1, wherein the first device has a plurality of alignment holes to receive a plurality of alignment posts formed on said mating face of the second device.

10. A device comprising:
a case including a mating face and a space behind the mating face;
a connector wafer assembly retractably received in said space and including a plurality of LGA contacts;
a first actuating device actuating the connector wafer assembly to move toward said mating face and drive the LGA contacts exposed upon the mating face when said device is being used;
a second actuating device actuating the connector wafer assembly to move away from said mating face and drive the LGA contacts hide behind said mating face when said device is out of use.

11. The device as claimed in claim 10, wherein the connector wafer assembly includes a housing defining a plurality of passageways with said LGA contacts retained therein, the mating face has a plurality of through holes passing therethrough and in alignment with the corresponding passageways to allow contacting sections of said LGA contacts to protrude therethrough when said device is being used.

12. The device as claimed in claim 10, wherein the first actuating device comprises magnetic elements integrally formed on the connector wafer assembly, the mating face has openings passing therethrough to receive the corresponding magnetic elements when said device is being used.

13. The device as claimed in claim 10, wherein the first actuating device comprises buttons for pressing corresponding cams to lift said connector wafer assembly when said device is being used.

14. The device as claimed in claim 10, wherein the second actuating device comprises a plurality of springs retained on corners of the connector wafer assembly and constantly and resiliently resisting the mating face away from the connector wafer assembly.

15. An electrical assembly comprising:
a first device forming a first mating area with a first magnetic element and conductive pads thereon;
a second device forming a second mating area with a second magnetic element and LGA (Land Grid Array) contacts thereon, said LGA contacts being retractable in a direction perpendicular to said second mating area between a hidden position behind the second mating area and an exposed position beyond the second mating area in said vertical direction;
an actuating device located at least on one said first device and second device to actuate said LGA contacts to move from the hidden position to the exposed position only when the first mating area and the second mating area are mutually intimately mated with each other with sharing a same interface by the combined first magnetic element and second magnetic element via magnetic attraction thereof.

16. The electrical assembly as claimed in claim 15, wherein said actuating device includes a third magnetic element on the first device and a fourth magnetic element on the second device mutually attracted with each other once the first magnetic element and the second magnetic element are combined together.

17. The electrical assembly as claimed in claim 16, wherein said actuating device is a cam structure in a lever manner.
